(19) United States
(12) Patent Application Publication
(10) Pub. No.: US 2009/0133057 A1
(43) Pub. Date: May 21, 2009

(54) Revenue Techniques Involving Segmented Content and Advertisements

(75) Inventors: Peter T. Barrett, San Francisco, CA (US); David H. Sloo, Menlo Park, CA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/943,607

(22) Filed: Nov. 21, 2007

(51) Int. Cl. H04N 7/10

(52) U.S. Cl. 725/34

(57) ABSTRACT

Revenue techniques involving segmented content and advertisements are described. In an implementation, content, which has one or more advertisements embedded by a content provider, is segmented into a plurality of segments. An identification is performed to determine which of the plurality of segments are program segments. An identification is also performed to determine which of the plurality of segments are advertising segments, at least one of the advertising segments includes at least one of the advertisements. An option is provided to pay to output the program segments without output of the advertising segments.

### BACKGROUND

Advertising continues to be one of the major driving factors used to generate revenue by content providers and network operators. In traditional advertising models, advertisements were embedded in content, such as television programs, which were then broadcast “over the air” to consumers such that the consumers were able to consume the content. Thus, in this traditional model revenue collected from advertisers was used to support the provision of the content to users. However, functionality has been developed that reduces the perceived effectiveness of traditional advertising models.

Users, for example, may use digital video recorder (DVR) functionality to record content and output it when desired and thereby “time shift” an output of the content. The user may also use DVR functionality to time shift the content as it is being output, such as to fast forward through portions of the content that include advertisements. This fast forwarding of advertisements has been perceived as reducing and even defeating the value of the advertisements. Therefore, because the traditional advertising models do not address this added functionality, the perceived value (either rightly or wrongly) of the advertising opportunities that are purchased by the advertisers is lessened and therefore the available revenue that is collected by content providers is often reduced.

### SUMMARY

Revenue techniques involving segmented content and advertisements are described. In an implementation, content, which has one or more advertisements embedded by a content provider, is segmented into a plurality of segments. An identification is performed to determine which of the plurality of segments are program segments. An identification is also performed to determine which of the plurality of segments are advertising segments, at least one of the advertising segments includes at least one of the advertisements. An option is provided to pay to output the program segments without output of the advertising segments.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an exemplary implementation that is operable to employ revenue techniques involving segmented content and advertisements.

FIG. 2 is an illustration of a system showing a network operator and clients of FIG. 1 in greater detail.

FIG. 3 is a flow diagram depicting a procedure in an exemplary implementation in which content is segmented into program and advertising segments and an option is provided to output the program segments without output of the advertising segments.

FIG. 4 is an illustration of an exemplary implementation of an option to pay to output content without advertisements that were originally embedded in the content.

FIG. 5 is a flow diagram depicting a procedure in an exemplary implementation in which content is arranged so as not to include advertising segments and revenue is distributed which is collected from a client to receive the content.

### DETAILED DESCRIPTION

Overview

Users have access to an increasing range of content and techniques that may be used to consume that content, such as video-on-demand, digital video recorders, digital television systems that offer interactive programming, and so on. Traditional advertising models, however, did not address this increasing functionality and further may even be hampered by this increased functionality, such as to skip television advertisements in traditional broadcast content using a digital video recorder (DVR). The perception that these techniques defeat these advertising models may have a negative impact on advertising revenue regardless of whether the techniques actually do.

Revenue techniques are described that involve segmented content and advertisements. In an example, content may be received that has embedded advertisements, such as a television program advertisements obtained from a “national” and/or “local” level. This content may be segmented in program segments (e.g., portions of the television program) and advertising segments (e.g., portions that include the advertisements). This segmentation may be performed in a variety of ways, such as manually by a technician of a network operator, automatically through execution of a module by a computing device, and so on.

An option may then be provided to a user to output the content, and more particularly the program segments, without the advertising segments. For example, a user interface may be output that prompts a user that output of the content without advertisements is available for a fee. Upon payment of the fee, the user may consume the content without the advertisements, such as by receiving the program segments without the advertising segments. In an implementation the user may still be given the option to forgo payment of the fee and consume the content with the advertisements, e.g., the program and advertising segments. In this way, a revenue model may be supported that addresses a user's desire to skip output of advertisements and also provide an option to view the content with the advertisements, further explanation of which may be found in relation to the following discussion.

In the following discussion, an exemplary environment is first described that is operable to employ revenue techniques that involve segmented content and advertisements. Exemplary procedures are then described that may be employed in the exemplary environment, as well as in other environments. Although these techniques are described as employed within a television environment in the following discussion, it should be readily apparent that these techniques may be incorporated within a variety of environments without departing from the spirit and scope thereof.

Exemplary Environment

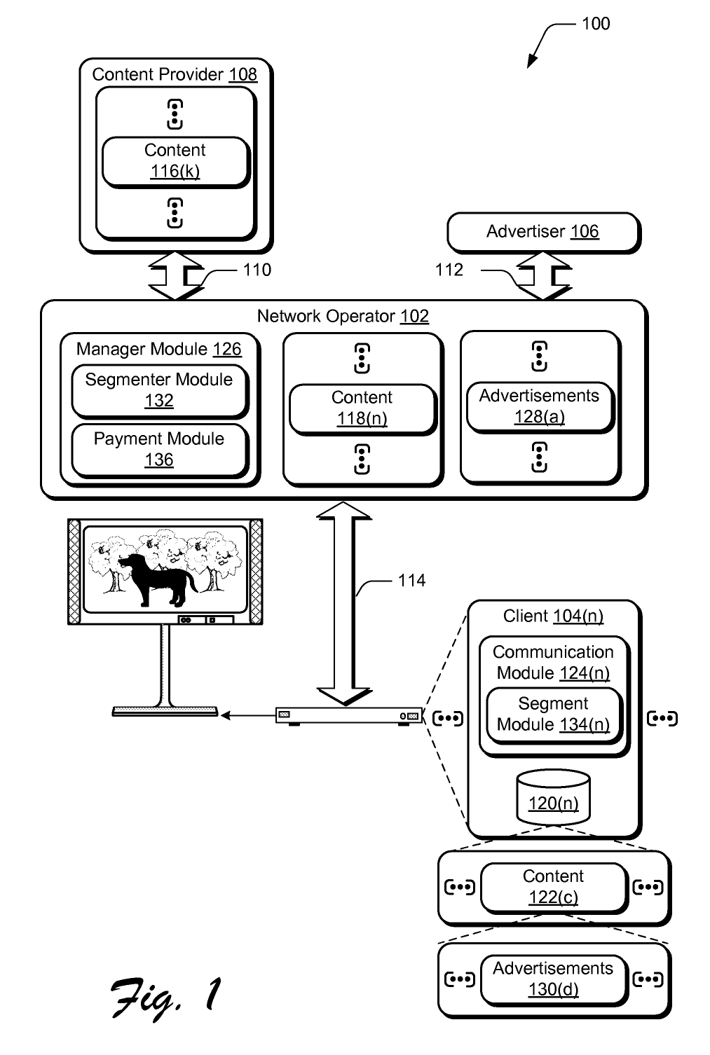

FIG. 1 is an illustration of an environment 100 in an exemplary implementation that is operable to employ revenue techniques that involve segmented content and advertisements. The illustrated environment 100 includes a network operator 102 (e.g., a “head end”), one or more clients 104(n), an advertiser 106 and a content provider 108 that are communicatively coupled, one to another, via network connections 110, 112, 114. In the following discussion, the network operator 102, the client 104(n), the advertiser 106 and the content provider 108 may be representative of one or more entities, and therefore reference may be made to a single entity (e.g., the client 104(n)) or multiple entities (e.g., the clients 104(n), the plurality of clients 104(n), and so on). Additionally, although a plurality of network connections 110-114 are shown separately, the network connections 110-114 may be representative of network connections achieved using a single network or multiple networks. For example, network connection 114 may be representative of a broadcast network with back channel communication, an Internet Protocol (IP) network, and so on.

The client 104(n) may be configured in a variety of ways. For example, the client 104(n) may be configured as a computer that is capable of communicating over the network connection 114, such as a desktop computer, a mobile station, an entertainment appliance, a set-top box communicatively coupled to a display device as illustrated, a wireless phone, and so forth. For purposes of the following discussion, the client 104(n) may also relate to a person and/or entity that operate the client. In other words, client 104(n) may describe a logical client that includes a user, software and/or a machine (e.g., a client device).

The content provider 108 includes one or more items of content 116(k), where “k” can be any integer from 1 to “K”. The content 116(k) may include a variety of data, such as television programming, video-on-demand (VOD) files, and so on. The content 116(k) is communicated over the network connection 110 to the network operator 102.

Content 116(k) communicated via the network connection 110 is received by the network operator 102 and may be stored as one or more items of content 118(n), where “n” can be any integer from “1” to “N”. The content 118(n) may be the same as or different from the content 116(k) received from the content provider 108. The content 118(n), for instance, may include additional data for broadcast to the client 104(n), such as electronic program guide (EPG) data.

The client 104(n), as previously stated, may be configured in a variety of ways to receive the content 118(n) over the network connection 114. The client 104(n) typically includes hardware and software to transport and decrypt content 118(n) received from the network operator 102 for rendering by the illustrated display device. Although a display device is shown, a variety of other output devices are also contemplated, such as speakers.

The client 104(n) may also include digital video recorder (DVR) functionality. For instance, the client 104(n) may include a storage device 120(n) to record content 118(n) as content 122(c) (where “c” can be any integer from one to “C”) received via the network connection 114 for output to and rendering by the display device. The storage device 120(n) may be configured in a variety of ways, such as a hard disk drive, a removable computer-readable medium (e.g., a writable digital video disc), and so on. Thus, content 122(c) that is stored in the storage device 120(n) of the client 104(n) may be copies of the content 118(n) that was streamed from the network operator 102. Additionally, content 122(c) may be obtained from a variety of other sources, such as from a computer-readable medium that is accessed by the client 104(n), and so on.

The client 104(n) includes a communication module 124(n) that is executable on the client 104(n) to control content playback on the client 104(n), such as through the use of one or more “command modes”. The command modes may provide non-linear playback of the content 122(c) (i.e., time shift the playback of the content 122(c)) such as pause, rewind, fast forward, slow motion playback, and the like.

The network operator 102 is illustrated as including a manager module 126. The manager module 126 is representative of functionality to configure content 118(n) for output (e.g., streaming) over the network connection 114 to the client 104(n). The manager module 126, for instance, may configure content 116(k) received from the content provider 108 to be suitable for transmission over the network connection 114, such as to “packetize” the content for distribution over the Internet, configuration for a particular broadcast channel, map the content 116(k) to particular channels, and so on.

Thus, in the environment 100 of FIG. 1, the content provider 108 may broadcast the content 116(k) over a network connection 110 to a multiplicity of network operators, an example of which is illustrated as network operator 102. The network operator 102 may then stream the content 118(n) over a network connection to a multitude of clients, an example of which is illustrated as client 104(n). The client 104(n) may then store the content 118(n) in the storage device 120(n) as content 122(c), such as when the client 104(n) is configured to include digital video recorder (DVR) functionality.

The content 118(n) may also be representative of time-shifted content, such as video-on-demand (VOD) content that is streamed to the client 104(n) when requested, such as movies, sporting events, and so on. For example, the network operator 102 may execute the manager module 126 to provide a VOD system such that the content provider 108 supplies content 116(k) in the form of complete content files to the network operator 102. The network operator 102 may then store the content 116(k) as content 118(n). The client 104(n) may then request playback of desired content 118(n) by contacting the network operator 102 (e.g., a VOD server) and requesting a feed (e.g., stream) of the desired content.

In another example, the content 118(n) may further be representative of content (e.g., content 116(k)) that was recorded by the network operator 102 in response to a request from the client 104(n), in what may be referred to as a network DVR example. Like VOD, the recorded content 118(n) may then be streamed to the client 104(n) when requested. Interaction with the content 118(n) by the client 104(n) may be similar to interaction that may be performed when the content 122(c) is stored locally in the storage device 120(n).

To collect revenue using a traditional advertising model, the content provider 108 may embed advertisements in the content 116(k). Likewise, the network operator 102 may also embed advertisements 128(a) obtained from the advertiser 106 in the content 118(n) to also collect revenue using the traditional advertising model. For example, the content provider 108 may correspond to a “national” television broadcaster and therefore offer the content 116(k) and national advertising opportunities to advertisers, which are then embedded in the content 116(k). The network operator 102, on the other hand, may correspond to a “local” television broadcaster and offer the content 118(n) with the advertisements embedded by the content provider 108 as well as advertisements obtained from local advertisers to the client 104(n). Thus, the advertisements 130(d) which are included with the content 122(c) streamed to the client 104(n) may be provided from a variety of sources. Although national and local examples were described, a wide variety of other examples are also contemplated.

The manager module 126 is illustrated as including a segment module 132 which is representative of functionality to segment content (e.g., content 118(n)), into program segments and advertising segments. The segments, therefore, are distinct time segments of the content 118(n) that are differentiated by “what” is contained in the segments, in this case the program or advertising. Segmenting the content is not limited to the network operator 102 and may be performed by a variety of different entities, such as by a segment module 134(n) by the client 104(n) as illustrated in FIG. 1. The segmenting of content for provision to the client 104(n) may be used to support a variety of different revenue generation techniques.

The network operator 102, for instance, is also illustrated as including a payment module 136 which is representative of functionality to collect payment from the client 104(n) based on the willingness of the client 104(n) to pay to consume the content 122(c) without the advertisements 130(d). For example, the network operator 102 may provide an option to the client 104(n) to record content 122(c) without the advertisements 130(d) upon payment of a fee, receive the content 122(c) over the network 114 that includes program segments and not advertising segments, and so on. Thus, the environment 100 may employ techniques to collect revenue from clients 104(n) when the clients do not wish to view advertisements and thus operate “outside” traditional advertising models. Further, should the client 104(n) not wish to provide payment, the content 118(n) may be provided with the advertisements 128(a) and thus also support the traditional advertising models. In this way, segmentation may support a variety of different revenue models at the same time which was not previously available, further discussion of which may be found in relation to the following figure.

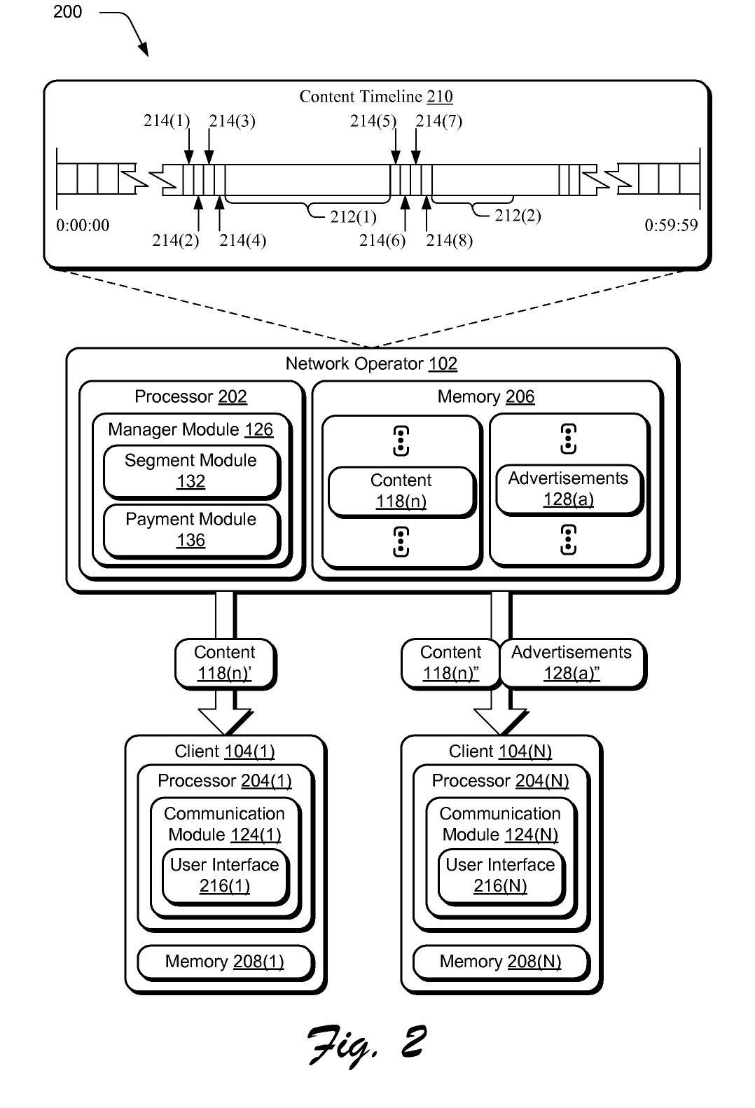

FIG. 2 depicts a system 200 in an exemplary implementation showing the network operator 102 of FIG. 1 and clients 104(1)-104(N) in greater detail. The client 104(1)-104(n) may or may not correspond to the client 104(n) of FIG. 1. The network operator 102 and the clients 104(1)-104(N) are both illustrated as devices (e.g., the clients 104(1)-104(N) are illustrated as client devices) having respective processors 202, 204(1)-204(N) and memory 206, 208(1)-208(N). Processors are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions. Additionally, although a single memory 206, 208(1)-208(N) is shown, respectively, for the network operator 102 and the clients 104(1)-104(N), a wide variety of types and combinations of memory may be employed, such as random access memory (RAM), hard disk memory, removable medium memory, and other types of computer-readable media.

Traditional content is typically shown according to a pre-determined and static payment scheme. For example, traditional “free-to-air” content is typically supported through the use of advertisements. “Premium” content, in another example, is made available via subscription and is typically viewed without traditional advertising, although advertising may be included such as before or after the program for future airings of the program, related programs by the content provider, and so on. In a further example, “on-demand” content is typically paid for the client before received, e.g., before viewing and/or recording in a DVR example. However, in each of these examples payment is inflexible and does not address the different ways in which the content may be consumed. By segmenting the content in program and advertising segments, flexible revenue models may be supported to address these different ways.

The network operator 102, for example, is illustrated as executing the manager module 126 having the segment module 132 and the payment module 136 on the processor 202, which is storable in memory 206. As previously described, the segment module 132 is representative of functionality to segment content 118(n) into distinct time segments, an example of which is illustrated by a content timeline 210 in FIG. 2.

The content timeline 210 includes a plurality of distinct time segments to be output, which are illustrated as blocks, which may be segmented through execution of the segment module 132. The segment module 132 may also differentiate between program segments 212(1), 212(2) and advertising segments 214(1), 214(2), 214(3), 214(4), 214(5), 214(6), 214(7), 214(8). These segments may then be provided in a variety of ways to the client 104(1)-104(N) to support different revenue models.

The client 104(1), for instance, may output a user interface 216(1) that gives an option of whether to obtain the content 118(n) without advertisements 128(a) upon payment of a fee. Once the fee is collected in this instance, the content 118(n)′ is provided to the client 104(1) without advertisements 128(a), such as by reassembling the program segments 212(1)-212(2) so as not to include the advertising segments 214(1)-214(7). Thus, in this example the advertisements 128(a) are not communicated to the client 104(1), thereby saving network and client 104(1) resources.

In another example, client 104(N) may also output a user interface 216(N) giving the option to forgo output of the advertisement 128(a). In this example, however, the client 104(N) does not wish to pay the fee. Therefore, the content 118(n)″ and the advertisements 128(a)″ are streamed to the client 104(N) for output, thereby supporting a traditional advertising model. Further discussion of revenue techniques involving segmented content and advertisements may be found in relation to the following exemplary procedures.

Generally, any of the functions described herein can be implemented using software, firmware, hardware (e.g., fixed-logic circuitry), manual processing, or a combination of these implementations. The terms “module”, “functionality” and “logic” as used herein generally represent software, firmware, hardware, or a combination thereof. In the case of a software implementation, for instance, the module, functionality, or logic represents program code that performs specified tasks when executed on a processor (e.g., CPU or CPUs). The program code can be stored in one or more computer-readable memory devices. The features of the revenue techniques involving segmented content and advertisements are platform-independent, meaning that the techniques may be implemented on a variety of commercial computing platforms having a variety of processors.

Exemplary Procedures

The following discussion describes subtitle data techniques that may be implemented utilizing the previously described environment, systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1 and the system 200 of FIG. 2.

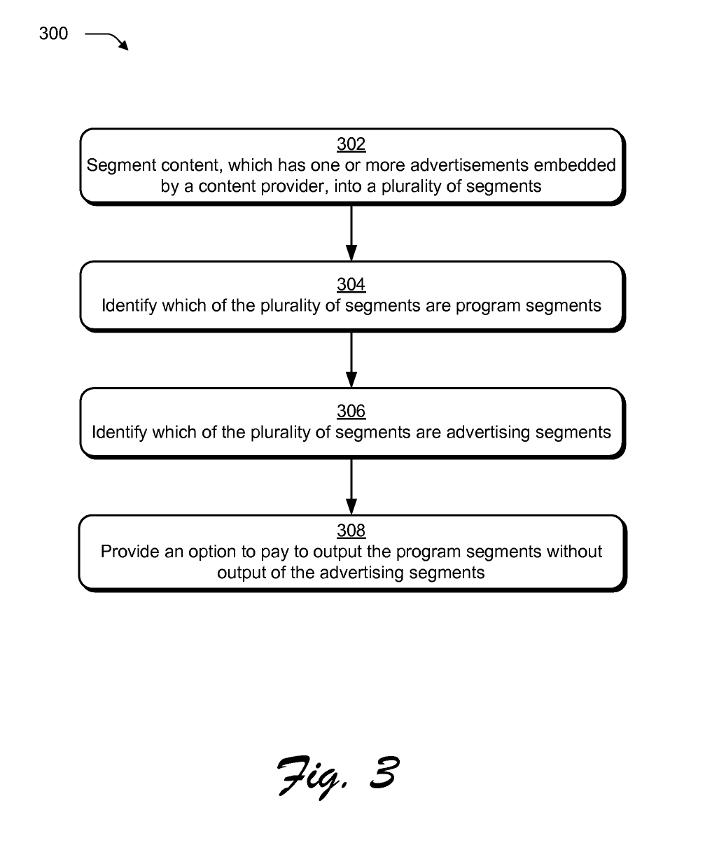

FIG. 3 depicts a procedure 300 in an exemplary implementation in which content is segmented into program and advertising segments and an option is provided to output the program segments without output of the advertising segments. Content is segmented, which has one or more advertisements embedded by a content provider, into a plurality of segments (block 302). The content, for instance, may be received by a network operator from a content provider. The content provider may correspond to a “national” broadcaster (e.g., CBS, ABC, NBC) that originated the content and includes advertisements in the content to collect revenue.

The content may be segmented in a variety of ways. For example, the different segments of the content may be segmented into thirty second distinct time periods. In another example, “breaks” between segments may be identified. A variety of other examples are also contemplated.

An identification is performed to determine which of the plurality of segments are program segments (block 304). An identification is also performed to determine which of the plurality of segments are advertising segments (block 306). For example, characteristics may be used to differentiate program segments from advertising segments. For instance, a higher volume level is generally observed for advertising segments as opposed to program segments. Scene changes, musical selection, dialog characteristics, identification of static images, and so on are further examples of characteristics that may be used to differentiate between programs and advertisements. Additionally, the identification may be performed such that advertisements are differentiated, one from another using similar techniques.

An option is provided to pay to output the program segments without output of the advertising segments (block 308). A network operator 102, for instance, may cause the clients 104(1)-104(N) to output respective user interfaces 216(1)-216(N), an example of which is shown in the following figure.

Although the previous discuss was described as being performed automatically through execution of a module, a variety of techniques may be employed. For example, the module may also output a user interface to receive inputs from a user, such as where to segment the content, re-segmenting as desired by a user, and so on. The user interface may also provide a variety of different functionality, such as to receive annotations from the user to input additional information, such as data describing the segment, and so on.

Further, the segments may also be based at least in part on information embedded into the content, such as by the content provider, advertiser and so on. For example, a revenue model may be supported in which advertisers pay (e.g., bid) to annotate segments in content such that the advertiser's segments are searchable at a later time, may initiate automatic segmenting at a client, and so forth.

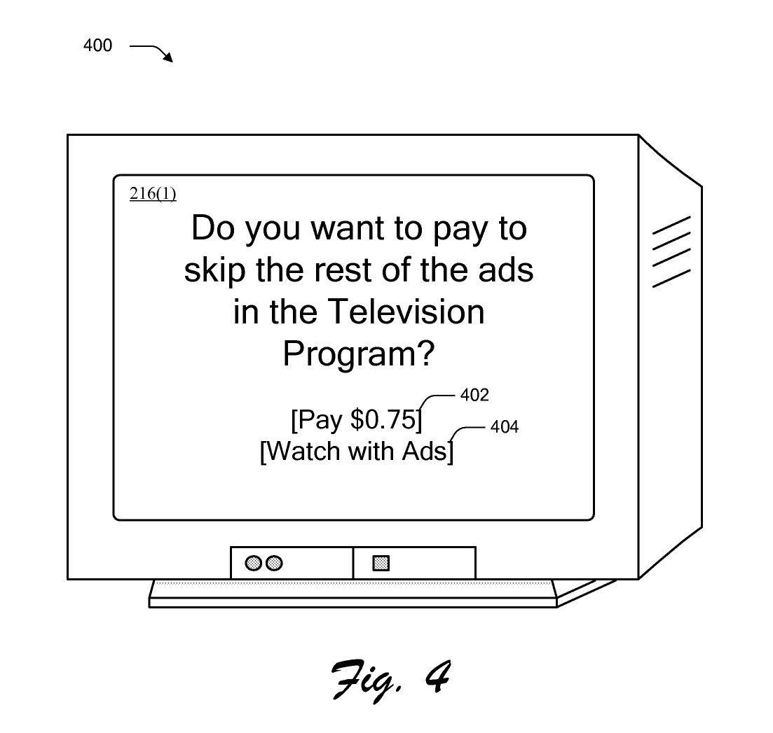

FIG. 4 illustrates an exemplary implementation 400 of an option to pay to output content without advertisements that were originally embedded in the content. A display device is shown as outputting the user interface 216(1) which includes language stating “Do you want to pay to skip the rest of the ads in the television program”. The user is then given a first option to “Pay $0.75” 402 to skip the ads and a second option to “Watch with Ads” 404. Selection of the options may cause payment information to be communicated to the network operator 102 to cause provision of content that meets the selected option. A variety of other examples of user interfaces and payment are also contemplated, such as by pressing a key on a remote control, sending of a message (e.g., an email) requesting segmented content, and so on.

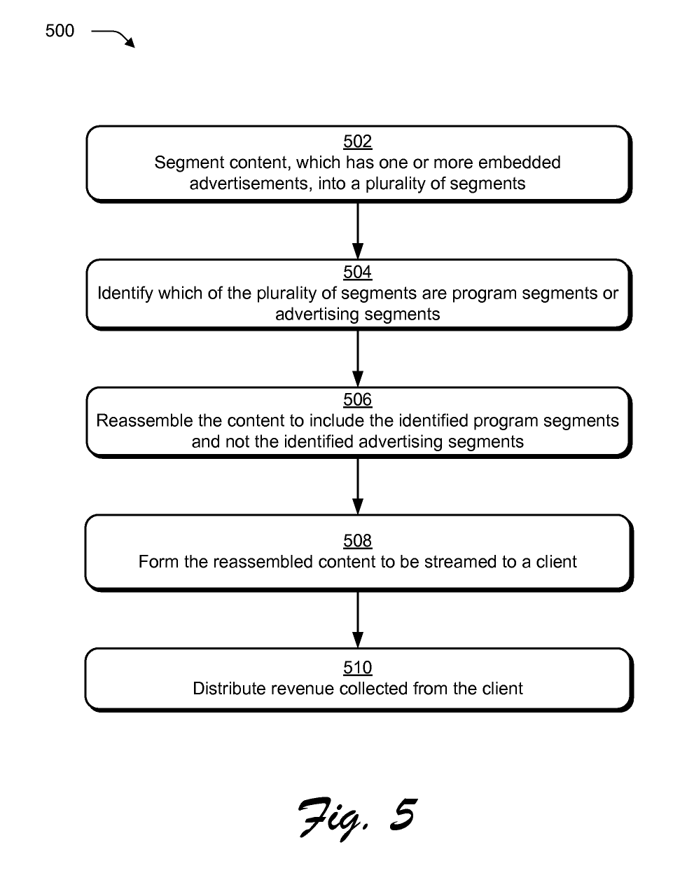

FIG. 5 depicts a procedure 500 in an exemplary implementation in which content is arranged so as not to include advertising segments and revenue is distributed which is collected from a client to receive the content. Content is segments which has one or more embedded advertisements, into a plurality of segments (block 502) and identification is performed as to which of the plurality of segments are program segments or advertising segments (block 504).

The content is then arranged to include the identified program segments and not the identified advertising segments (block 506). For example, the network operator 102 may segment content 118(n) as shown in the content timeline 210. The segment module 132 may then reassemble the content 118(n) to remove the advertising segments 214(1)-214(8) such that the program segments 214(1), 214(2) remain. This reassembled content 118(n)′ without the advertisements may then be formed to be streamed to a client (block 508). Thus, in this example the advertisements 128(a) are not communicated to the client 104(n), although other examples are contemplated in which the segment module 134 of the client 104(n) performs the reassembling.

Revenue collected from the client is distributed (block 510). For example, the network operator 102 may keep a portion of a payment provided by the client 104(n) to receive the reassembled content 118(n)′ without the advertisements 128(a). The network operator 102 may also share a portion of the revenue with the content provider 108 that originated the content 116(k) and/or embedded advertisements in the content. A variety of other examples are also contemplated.

### CONCLUSION

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method comprising:
segmenting content, which has one or more advertisements embedded by a content provider, into a plurality of segments;
identifying which of the plurality of segments are program segments;
identifying which of the plurality of segments are advertising segments, wherein at least one said advertising segment includes at least one said advertisement; and
providing an option to pay to output the program segments without output of the advertising segments.

2. A method as described in claim 1, wherein the identifying of which of the plurality of segments are program segments and the identifying of which of the plurality of segments are advertising segments is performed at least in part based on one or more inputs received via a user interface from a user.

3. A method as described in claim 2, wherein the user interface is further configured to receive one or more annotations from the user regarding one or more said segments.

4. A method as described in claim 1, wherein:
the content further includes one or more other advertisements that are embedded by a network operator; and
one or more said advertising segments include the one or more other advertisements.

5. A method as described in claim 1, further comprising streaming the program segments without the advertising segments upon selection of the option.

6. A method as described in claim 1, wherein the segmenting, the identifying of which of the plurality of segments are program segments and the identifying of which of the plurality of segments are advertising segments are performed without user intervention through execution of one or more modules.

7. A method as described in claim 1, wherein the segmenting, the identifying of which of the plurality of segments are program segments, the identifying of which of the plurality of segments are advertising segments and the providing are performed by a network operator.

8. A method as described in claim 7, wherein the option to pay causes the network operator to provide a user interface to be output by a client that is configured to implement the option upon user selection.

9. A method as described in claim 1, wherein the identifying which of the plurality of segments are advertising segments is based at least in part on one or more characteristics that distinguish the advertising segments from the program segments.

10. A method as described in claim 1, further comprising:
arranging the content to include the identified program segments and not the identified advertising segments; and
forming the arranged content to be streamed to a client.

11. A method comprising:
providing a first option to pay a fee to cause:
a stream of content to be segmented into program segments and advertising segments; and
the program segments to be streamed to a client without streaming the advertising segments; and
providing a second option to cause the program segments and the advertising segments to be streamed to the client without paying the fee.

12. A method as described in claim 11, wherein the stream of content is segmented into program segments and advertising segments by:
segmenting the stream of content, which has one or more advertisements embedded by a content provider, into a plurality of segments;
identifying which of the plurality of segments are the program segments; and
identifying which of the plurality of segments are the advertising segments, wherein at least one said advertising segment includes at least one said advertisement.

13. A method as described in claim 11, wherein the stream of content is segmented into the program segments and the advertising segments upon payment of the fee.

14. A method as described in claim 11, wherein at least a portion of the fee is retained by a network operator that provides the first and second options.

15. A method as described in claim 11, wherein at least a portion of the fee is provided to a content provider that embedded at least one advertisement in the stream.

16. A method as described in claim 11, wherein providing of the first and second options includes causing a user interface to be output at the client.

17. A client comprising one or more modules to:
output a user interface having a user-selectable option regarding content that includes programs and embedded advertisements; and
upon selection of the option, cause payment to be provided to receive segments of the content having the programs without segments of the content having the embedded advertisements.

18. A client as described in claim 17, wherein the content:
is received from a network operator; and
includes at least a portion of a television program.

19. A client as described in claim 17, wherein the user interface is output after at least a portion of the content is output at the client.

20. A client as described in claim 17, wherein the advertisements are embedded by a content provider that provides the content to a network operator to be streamed to the client:
